(19) United States
(12) Patent Application Publication
(10) Pub. No.: US 2003/0215606 A1
(43) Pub. Date: Nov. 20, 2003

(54) Dispersible dielectric particles and methods of forming the same

(76) Inventors: Donald J. Clancy, Pottstown, PA (US); Sridhar Venigalla, Pottstown, PA (US); Jeffrey A. Kerchner, Fleetwood, PA (US)

Correspondence Address: Martha Ann Finnegan, Esq., Cabot Corporation, 157 Concord Road, Billerica, MA, 01821, US

(21) Appl. No.: 10/150,761

(22) Filed: May 17, 2002

(51) Int. Cl. B32B 1/00

(52) U.S. Cl. 428/141

(57) ABSTRACT

Methods of forming dispersible dielectric particles, as well as articles and compositions that include the dispersible dielectric particles, are provided. The methods involve forming an aqueous mixture of dielectric (e.g., barium titanate-based) particles and replacing at least a portion of water in the mixture with a non-aqueous solvent (e.g., ethanol). According to one set of methods, the particles are then dried. The limited, or lack, of water present in the mixture during drying reduces capillary forces that otherwise may draw the particles together to cause formation of strong agglomerates. Thus, particle agglomeration during drying may be reduced which increases particle dispersibility. According to another set of methods of the invention, the particles are not dried after non-aqueous solvent replacement, thus, avoiding formation of agglomerates during drying and increasing dispersibility. In both sets of methods, particles (or mixtures thereof) may be further processed, for example, to form composite layers. As a result of the increased particle dispersibility, the particles are relatively uniformly distributed throughout the polymeric material. This uniform distribution improves properties of the composite layers which may be used as an embedded capacitor in electronic applications including printed circuit boards.

### FIELD OF INVENTION

The invention relates generally to dielectric materials and, more particularly, to methods of forming dispersible dielectric particles, as well as articles and compositions that include the dispersible dielectric particles.

### BACKGROUND OF INVENTION

Barium titanate-based compositions, which include barium titanate (BaTiO₃) and its solid solutions, may be used as dielectric materials in electronic devices. Barium titanate-based compositions are typically produced as small particles which are further processed to form the desired structure. In some cases, the particles are further processed to form a sintered dielectric layer, for example, in a multi-layer ceramic capacitor (MLCC). In other cases, the particles are distributed in a polymeric material to form a composite. Such composites are suitable for use as a dielectric layer, for example, in printed circuit boards. The composite dielectric layer may function as an embedded capacitor which can have property and processing advantages over conventional capacitor devices that are mounted on top of printed circuit boards.

When forming polymer and dielectric composite layers, it may be desirable to uniformly distribute particles in the polymeric material. Uniform distribution may advantageously increase electrical properties (e.g., capacitance) of the composite layer, increase production yields, and enable formation of thin composite layers. The uniformity of particle distribution within a composite layer may be limited by the agglomeration of particles during processing of the layer. Agglomerates may include one or more particles that are bonded together, for example, by electrostatic forces or by physical attachment (e.g., weak inter-particle necking).

Barium titanate-based particles may be agglomerated at different steps during the process. For example, the particles may be agglomerated when aqueous mixtures that include the particles are dried. The high surface tension of water generates relatively large capillary forces which draws the particles together as the water evaporates during drying. Once drawn together, the particles may form agglomerates.

### SUMMARY OF INVENTION

The invention provides methods of forming dispersible dielectric (e.g., barium titanate-based) particles, as well as articles and compositions that include the dispersible dielectric particles.

In one aspect, the invention provides a method of forming a composite. The method comprises forming an aqueous mixture including barium titanate-based particles and water, and replacing at least a portion of the water in the aqueous mixture with a non-aqueous solvent to form a non-aqueous mixture including the non-aqueous solvent and the barium titanate-based particles. The method further comprises drying the barium titanate-based particles in the non-aqueous mixture, and mixing the dried barium titanate-based particles with a second non-aqueous solvent and a precursor of polymeric material to form a second non-aqueous mixture. The method further comprises removing the second non-aqueous solvent from the second non-aqueous mixture to form a composite structure including barium titanate-based particles distributed in the polymeric material.

In one aspect, the invention provides a method of forming a composite. The method comprises forming an aqueous mixture including barium titanate-based particles and water, and replacing at least a portion of the water in the aqueous mixture with a non-aqueous solvent to form a non-aqueous mixture including the non-aqueous solvent and the barium titanate-based particles. The method further comprises adding a precursor of a polymeric material to the non-aqueous mixture, and removing the non-aqueous solvent from the non-aqueous mixture to form a composite structure including barium titanate-based particles distributed in the polymeric material.

In one aspect, the invention provides a composite layer. The composite layer includes barium titanate-based particles distributed in a polymeric material. The barium titanate-based particles is present in an amount of at least 50 percent by weight of the total composite layer. The composite layer has a surface roughness of less than about 500 nm.

Other aspects, embodiments, and features of the invention will become apparent from the following detailed description. All references incorporated herein are incorporated in their entirety. In cases of conflict between an incorporated reference and the present specification, the present specification shall control.

### BRIEF DESCRIPTION OF THE DRAWINGS

FIG. 1 shows a polymer and dielectric composite layer produced according to a conventional process as described in Example 1.

FIG. 2 shows a polymer and dielectric composite layer produced according to a one method of the present invention as described in Example 2.

### DETAILED DESCRIPTION

Methods of forming dispersible dielectric particles, as well as articles and compositions that include the dispersible dielectric particles, are provided. The methods involve forming an aqueous mixture of dielectric (e.g., barium titanate-based) particles and replacing at least a portion of water in the mixture with a non-aqueous solvent (e.g., ethanol). According to one set of methods, the particles are then dried. The limited, or lack, of water present in the mixture during drying reduces capillary forces that otherwise may draw the particles together to cause formation of strong agglomerates. Thus, as described further below, particle agglomeration during drying may be reduced which increases particle dispersibility. According to another set of methods of the invention, the particles are not dried after non-aqueous solvent replacement, thus, avoiding formation of agglomerates during drying and increasing dispersibility. In both sets of methods, particles (or mixtures thereof) may be further processed, for example, to form composite layers. As a result of the increased particle dispersibility, the particles may be uniformly distributed throughout the polymeric material in such composite layers. This uniform distribution improves properties of the composite layers which may be used as an embedded capacitor in electronic applications including printed circuit boards.

Barium titanate-based dielectric particles are preferably used in methods of the present invention. As used herein, “barium titanate-based” compositions refer to barium titanate, solid solutions thereof, or other oxides based on barium and titanium having the general structure ABO₃, where A represents one or more divalent metals such as barium, calcium, lead, strontium, magnesium and zinc and B represents one or more tetravalent metals such as titanium, tin, zirconium and hafnium. One type of barium titanate-based composition has the structure Ba₍₁₋ₓ₎AₓTi_{(1-y)}B_{y}O₃, where x and y can be in the range of 0 to 1, where A represents one or more divalent metal other than barium such as lead, calcium, strontium, magnesium and zinc and B represents one or more tetravalent metals other than titanium such as tin, zirconium and hafnium. Where the divalent or tetravalent metals are present as impurities, the value of x and y may be small, for example less than 0.1. In other cases, the divalent or tetravalent metals may be introduced at higher levels to provide a significantly identifiable compound such as barium-calcium titanate, barium-strontium titanate, barium titanate-zirconate and the like. In still other cases, where x or y is 1.0, barium or titanium may be completely replaced by the alternative metal of appropriate valence to provide a compound such as lead titanate or barium zirconate. In other cases, the compound may have multiple partial substitutions of barium or titanium. An example of such a multiple partial substituted composition is represented by the structural formula Ba_{(1-x-x′-x″)}PbₓCa_{x′}Sr_{x″}O.Ti_{(1-y-y′-y″)}Sn_{y}Zr_{y′}Hf_{y″}O₂, where x, x′, x″, y, y′, and y″ are each greater than or equal to 0. In many cases, the barium titanate-based material will have a perovskite crystal structure, though in other cases it may not.

It should be understood that though barium titanate-based particles are preferred, the methods of the invention may utilize other types of ceramic particles in some cases.

The barium titanate-based particles may have a variety of different particle characteristics. The barium titanate-based particles typically have an average primary particle size of less than about 5.0 microns; in some cases, the average primary particle size is less than about 1.0 micron; in some cases, the average primary particle size may be less than about 0.5 micron; in some cases, the average primary particle size is less than about 0.1 micron.

The barium titanate-based particles may have a variety of shapes which may depend, in part, upon the process used to produce the particles. The barium titanate-based particles may be equiaxed and/or substantially spherical, in particular, if the particles are hydrothermally produced as described further below. In some cases, the particles may have an irregular, non-equiaxed shape.

The barium titanate-based particles may be produced according to any technique known in the art including hydrothermal processes, solid-state reaction processes, sol-gel processes, as well as precipitation and subsequent calcination processes, such as oxalate-based processes. In some embodiments, it may be preferable to produce the barium titanate-based particles using a hydrothermal process. Hydrothermal processes generally involve mixing a barium source with a titanium source in an aqueous environment to form a hydrothermal reaction mixture which is maintained at an elevated temperature. Barium reacts with titanium to form barium titanate particles which remain dispersed in the aqueous environment to form a slurry. The particles may be washed to remove excess barium ions from the hydrothermal process while being maintained in the slurry. When forming barium titanate solid solution particles hydrothermally, sources including the appropriate divalent or tetravalent metal are also added to the hydrothermal reaction mixture. Certain hydrothermal processes may be used to produce substantially spherical barium titanate-based particles having an average primary particle size of less than about 0.5 micron and a uniform particle size distribution. Suitable hydrothermal processes for forming barium titanate-based particles have been described, for example, in commonly-owned U.S. Pat. Nos. 4,829,033, 4,832,939, and 4,863,883, which are incorporated herein by reference in their entireties.

In some cases, particles may be coated with dopant metals. The dopant metals are selected to impart the resulting composition with the desired properties (e.g., electrical properties such as dielectric constant and dissipation factor). Suitable dopant coatings and processes have been described, for example, in U.S. Pat. No. 6,268,054 which is incorporated herein by reference in its entirety.

In some embodiments of the invention, it may be preferable to use un-coated barium titanate-based particles. Un-coated barium titanate-based particles may be preferred, for example, in embodiments that involve production of polymer and dielectric composite layers.

As described above, the methods of the present invention involve formation of an aqueous mixture of barium titanate-based particles. When the particles are produced hydrothermally, the particles may be maintained in water after the hydrothermal process to form the aqueous slurry. When non-hydrothermal processes (e.g., solid-state reaction processes) are used to form the barium titanate-based particles, the particles may be mixed with water to form the aqueous mixture.

The aqueous mixture may include a range of different weight percentages of particles. In some cases, the mixture may include a relatively low weight percentage of particles and a relatively high weight percentage of water. For example, the weight percentage of particles may be less than about 50% of the total weight of the mixture; in other cases, the weight percentage of particles may be less than about 35%, or less than about 20% of the total weight of the mixture. A mixture that include a relatively low fraction of particles and high fraction of water may be referred to as an aqueous slurry.

In other cases, the mixture may include a relatively high weight percentage of particles and a low weight percentage of water. Such mixtures may be referred to as aqueous wet cakes. For example, the weight percentage of particles may greater than about 50% of the total weight of the mixture; in other cases, the weight percentage of particles may be greater than about 70%, or greater than about 85% of the total weight of the mixture.

It should be understood that the aqueous mixture may include other components. For example, the aqueous mixture may include ionic species (e.g., ionic species residual from a hydrothermal reaction, ammonium hydroxide). The aqueous mixture does not include a significant amount of non-aqueous solvent (e.g., greater than 10 weight percent) and, oftentimes, includes no non-aqueous solvent.

The methods of the invention involve replacing at least a portion of the water in the aqueous mixture with a non-aqueous solvent, such as ethanol. The replacement step forms a non-aqueous mixture. Any suitable solvent replacement (or solvent exchange) technique may be utilized. Solvent replacement typically involves removing water from the mixture and adding a non-aqueous solvent. In some cases, water may be removed prior to the addition of the non-aqueous solvent. In some cases, water may be removed, while adding the non-aqueous solvent. In some cases, a first portion of the water may be removed prior to the addition of the non-aqueous solvent and a second portion of the water may be removed while adding the non-aqueous solvent.

Solvent replacement may be accomplished using one or more filtration steps. The filtering step may first involve filtering the aqueous mixture to reduce its water content. The non-aqueous solvent may then added to the mixture, which typically still includes some water. In some cases, the mixture may be continuously filtered while the non-aqueous solvent is added. As more solvent is filtered through the mixture, the water content decreases and the solvent content increases. Filtration and solvent addition may continue until the desired amount of water in the mixture has been replaced with non-aqueous solvent. In other cases, the mixture is not filtered when the non-aqueous solvent is added. In these cases, the mixture may be filtered after the addition of non-aqueous solvent. This process of solvent addition followed by separate filtering may be repeated until the desired amount of water in the mixture has been replaced with non-aqueous solvent. Between separate filtering steps, the mixture may be agitated, for example, by a high shear mixing. In embodiments which utilize repeated filtering and non-aqueous solvent addition steps, a relatively inexpensive non-aqueous solvent may be utilized in the first several filtering steps after which an expensive non-aqueous solvent may be utilized in the final filtering step.

Solvent replacement may also be accomplished using a distillation process. For example, methods that use high molecular weight non-aqueous solvents, which have a higher boiling point than water, may utilize a distillation process. Distillation involves a mixed batch distillation vessel, a condensing heat exchanger, and a phase separation tank. In operation, the aqueous mixture is pumped into the distillation tank, and the desired non-aqueous solvent is added. If the desired non-aqueous solvent is not miscible in water, a small amount of a water-miscible solvent, such as a high molecular weight alcohol, can be added. The components are then mixed to an emulsion and heated. The heating of the mixture selectively drives off water, leaving the particles dispersed in the non-aqueous solvent. The phase separation tank, located downstream of a condenser unit, separates the water from any non-aqueous solvent which is removed during the distillation. The non-aqueous solvent may then pumped back into the distillation vessel, and water may be pumped to waste. A vacuum can also be used with the phase separation tank to force the distillation to occur at a lower temperature. During the distillation process dispersant can be added to prevent the slurry from solidifying in the distillation vessel. Once the desired reduction of water content is achieved, the non-aqueous solvent is no longer recycled and the process ceases.

In some embodiments, solvent replacement may be accomplished using both a distillation technique and a filtration technique. For example, the aqueous mixture may be filtered prior to distillation. In either the distillation or the filtration processes, if a low water content is desired, the mixture can be fed through a bed containing a desiccant, such as activated silica, or activated alumina.

A number of different non-aqueous solvents may be utilized in the methods of the present invention. In methods that involve a subsequent drying step, suitable non-aqueous solvents include solvents that generate less capillary forces than water during drying. In methods that do not involve a subsequent drying step, suitable non-aqueous solvents may be selected for compatibility with downstream processing (e.g., non-aqueous solvents compatible with processes for forming composite polymer and dielectric composites). Some suitable non-aqueous solvents have a lower surface tension than water. Suitable non-aqueous solvents include, but are not limited to, alcohols, ketones and organic acids. Examples of suitable solvents are MIBK (4 methyl-2pentanone) benzene, methyl ethyl ketone, acetone, xylene, methanol, ethanol, propanol, 1,1,1-trichloroethane, tetrachloroethylene, amyl acetate, 2,2,4-triethyl pentanediol-1,3-monoisobutyrate, toluene, methylene chloride, turpentine, ethyl alcohol, bromochloromethane, butanol, diacetone, methyl isobutyl ketone, cyclohexanone, methyl alcohol, n-propyl alcohol, isopropyl alcohol, n-butyl alcohol, n-octyl alcohol, benzyl alcohol, glycerol, ethylene glycol, benzaldehide, propionic acid, n-octanoic acid, ethylacetate, butylbutyrate, n-hexane, NMP (1-methyl, 2 pyrrolidnone), and mixtures thereof. Suitable solvent mixtures can include, for example, 72% trichlorethylene/28% ethyl alcohol, 66% methyl ethyl ketone/34% ethyl alcohol, 70% methyl ethyl ketone/30% ethyl alcohol, 59% methyl ethyl ketone/41% ethyl alcohol, 50% methyl ethyl ketone/50% ethyl alcohol, 80% toluene/20% ethanol, 80% toluene/20% ethyl alcohol, 70% toluene/30% ethyl alcohol, 60% toluene/40% ethyl alcohol, 70% isopropyl alcohol/30% methyl ethyl ketone, 40% methyl ethyl ketone/60% ethyl alcohol.

After the solvent replacement step, it should be understood that the non-aqueous mixture may include some water. For example, the liquid portion of the non-aqueous mixture may include less than about 50% by weight water with the balance being non-aqueous solvent. In some cases, the liquid portion of the non-aqueous mixture may include less than about 25% by weight water; and, in other cases less than about 5% by weight water (balance being non-aqueous solvent). In some cases, substantially all of the water is replaced by the non-aqueous solvent (i.e., the liquid portion of the non-aqueous mixture includes less than about 1% by weight water). The desired water content may depend upon the particular application. In general, the water content may be reduced to an amount that renders the particles sufficiently dispersible.

It should be understood that the non-aqueous mixture may include other components (e.g., residual ionic species, additives, and the like) after solvent replacement and that other components may be added to the non-aqueous mixture, as described further below.

The non-aqueous mixture formed by solvent replacement may include a range of different weight percentages of particles. The weight percentage of particle in the mixture may depend in part on the solvent replacement technique or the requirements of a particular process. In some cases, the non-aqueous mixture may include a relatively high weight percentage of particles and a low weight percentage of non-aqueous solvent (i.e., a non-aqueous wet cake). For example, the weight percentage of particles may be greater than about 70% of the total weight of the mixture; in other cases, the weight percentage of particles may be greater than about 80%, or greater than about 95% of the total weight of the mixture. Non-aqueous mixtures that include relatively high weight percentage of particles and a low weight percentage of non-aqueous solvents may, for example, be formed in filtration processes.

In other cases, the non-aqueous mixture (at least initially) may include a relatively low weight percentage of particles and a relatively high weight percentage of non-aqueous solvent (i.e., a non-aqueous slurry). For example, the weight percentage of particles may be less than about 70% of the total weight of the mixture; in other cases, the weight percentage of particles may be less than about 50%, or less than 30% of the total weight of the mixture.

In some methods of the invention, a surface modification step may be utilized. In this step, a coupling agent (e.g., a silane coupling agent) may be added to the non-aqueous mixture which attach to particle surfaces. Surface-modification may enhance the dispersibility of particles in some cases. Suitable surface modification techniques have been described, for example, in commonly-owned U.S. provisional patent application serial No. 60/323,946, filed Sep. 21, 2001, which is incorporated herein by reference in its entirety. It should be understood that the surface modification step may be conducted at a later point in certain methods of the invention (e.g., after drying and formation of a second non-aqueous mixture).

As noted above, some methods of the invention involve drying the particles in the non-aqueous mixture. Prior to drying, a filtration step may be conducted, if necessary, to remove excess non-aqueous solvent thereby increasing the weight percentage of particles in the mixture. When the non-aqueous mixture already includes a high weight percentage of particles (e.g., when filtration is used for solvent replacement), this additional filtration step is generally not necessary. The particles may be dried at any suitable temperature, for example, between about 100° C. and about 250° C. The specific drying temperature and time may depend, in part, on the type of non-aqueous solvent used. A vacuum drying furnace or any other suitable furnace may be utilized.

Particle agglomeration during drying of the non-aqueous mixture may be reduced as compared when aqueous mixtures are dried. The limited amounts (or absence) of water in the non-aqueous mixture reduces inter-particle capillary forces that arise during drying. This reduction in inter-particle capillary forces lessens the tendency of particles to become drawn together during drying which may cause formation of strong agglomerates. Though some particle agglomeration typically arises during drying of non-aqueous mixtures, the agglomerates are generally smaller and/or easier to disperse than agglomerates formed during the drying of aqueous mixtures. This reduction in agglomeration results in the particles having excellent dispersibility which can enhance distribution of the particles within polymeric materials during the processing of composite layers, as described further below.

In some embodiments, the particles may be subjected to a hydroxyl removal step after drying to remove hydroxyl groups from particle surfaces. The hydroxyl removal step involves heating the particles to a temperature, for example, between about 300° C. and about 500° C. This step may increase the dispersibility of particles in some cases. Suitable hydroxyl removal processes are described, for example, in commonly-owned U.S. provisional patent application serial No. 60/323,946, filed Sep. 21, 2001, which is incorporated herein by reference in its entirety. It should be understood, in some embodiments, the particles are not subjected to a hydroxyl removal step.

In some embodiments, the particles may be subjected to a heat treatment step after drying. The heat treatment step involves heating the particles, for example, to a temperature between about 700° C. and about 1150° C. to increase average particle size. In some cases, the increased average particle size may improve the electrical properties (i.e., dielectric constant and dissipation factor) of the heat-treated composition. Suitable heat treatment processes are described in commonly-owned, co-pending U.S. patent application Ser. No. 09/689,093, which was filed on Sep. 12, 2000, and is incorporated herein by reference in its entirety. It should be understood, in some embodiments, the particles are not heat-treated.

In embodiments which utilize a drying step, the dispersible, dried particles may be further processed as desired. In some cases, the dried particles may be subjected to a dry milling step to reduce particle agglomeration, if present. Any suitable milling processes may be utilized including hammer milling, ball milling, pin milling, long gap milling, and jet milling. In some cases, hammer milling may be particularly effective in reducing agglomeration. A suitable hammer mill is a Micro-Pulverizer SH#1, manufactured by Hosokawa Mikron Powder Systems (Summit, N.J.). Typically, dry milling time and/or energy required to achieve a desired particle size distribution can be significantly reduced using the methods of the invention as compared to other processes that dry aqueous particulate mixtures. The reduction in milling time and/or energy results from the reduced size and/or strength of agglomerates described above. It should be understood, however, that the specific milling time depends, in part, on the particular process and milling technique used.

In some methods of the invention, a dry milling step is not required. The dry milling step may advantageously be avoided in some cases, as a result of the reduced agglomeration in the particles produced according to methods of the present invention.

Some methods may use a particle size classification step such as screening or air classification to remove larger agglomerates, if present. The screening step generally involves sifting the dried particles through a screen having holes of a certain mesh size. The screen may be vibrated to enhance sifting. In some cases, media also may be added to the particles during sifting. Agglomerates larger than the mesh size can be captured on the mesh and removed from the dried particle composition. It should be understood that the particle size classification step is optional and that, in some cases, it may advantageously be avoided because of the reduced agglomeration in the particles produced according to methods of the present invention.

In some embodiments, the dispersible, dried particles (which may or may not be milled and/or screened) are again mixed with a non-aqueous solvent to form a non-aqueous mixture. The non-aqueous solvent may be further processed, for example, to form a layer in an electronic structure, as described further below. The non-aqueous solvent is selected to be compatible with subsequent processing steps. Generally, any suitable non-aqueous solvent may be selected. Any of the non-aqueous solvents described above may be utilized. In processes in which the non-aqueous mixtures are processed to form polymer and dielectric composite layers, MEK, NMP (1-methyl, 2 pyrrolidnone), or MIBK (4 methyl-2pentanone) may be preferred.

In some embodiments, the dispersible, dried particles (which may or may not be milled and/or screened) may be mixed with water (which may include other components) to form a non-aqueous mixture. The aqueous mixture may be further processed as desired.

In embodiments in which the dispersible, dried particles are mixed with a non-aqueous solvent, it should be understood that the non-aqueous solvent used to form the second non-aqueous mixture may be different than the non-aqueous solvent used to form the first non-aqueous mixture (i.e., during the solvent replacement step) described above. For example, ethanol may be used in the solvent replacement step and NMP (1-methyl, 2 pyrrolidnone) may be used to form the second non-aqueous mixture. It should also be understood that the non-aqueous solvent used to form the second non-aqueous mixture may be the same as the non-aqueous solvent used to form the first non-aqueous mixture.

The second non-aqueous mixture may include a range of different weight percentages of particles. The weight percentage of particles in the mixture depends, in part, on the subsequent processing steps. In some cases, the non-aqueous mixtures may include a relatively high weight percentage of particles and a low weight percentage of non-aqueous solvent (i.e., a non-aqueous wet cake). In other cases, the non-aqueous mixtures may include a relatively low weight percentage of particles and a high weight percentage of non-aqueous solvent (i.e., a non-aqueous slurry). Any of the weight percentages described above in connection with the non-aqueous slurry formed during the solvent replacement step are suitable.

It should be understood that the non-aqueous mixture may include other components. The components may be mixed with the non-aqueous solvent prior to mixing with the particles, or may be added to the non-aqueous solvent and particle mixture. The other components in the mixture are selected based on processing requirements. When a polymer dielectric composite layer is being formed from the non-aqueous mixture, the mixture may include a precursor of polymeric material, a dispersant, and a curing agent. As used herein, the term “precursor of polymeric material” refers to a component or components that are capable of becoming a polymeric material upon further processing, such as in a curing step. The precursor of polymeric material may be dissolved in the second solvent. Suitable polymeric precursors may be precursors of epoxies, polyamides, polyimides, polycarbonate, polyethylene, polyethylene terephthalate, polypropylene, polystyrene, polyphenylene oxide, polyesters, or other polymeric materials.

The particles and non-aqueous solvent mixture may optionally be subjected to a further high shear mixing and/or wet milling step to reduce particle agglomeration, if present. In some cases, it may be advantageous to utilize high shear mixing instead of a wet milling, for example, because high shear mixing uses less energy and is less invasive than wet milling. Suitable high shear mixers are commercially available including Silverson L4RT (manufactured by Silverson Machines Incorporated, East Longmeadow, Mass.) and Ross Models ME-105 and ME-110 (manufactured by Charles Ross and Son Company, Hauppauge, N.Y.). Suitable wet milling machines are manufactured by Premier Mill (Reading, Pa.).

It should be understood that the wet milling and/or high shear mixing steps are optional and that, in some cases, these steps may advantageously be avoided because of the reduced agglomeration in the particles produced according to methods of the present invention.

The increased particle dispersibility may also advantageously enable elimination of a settling step which may be used in certain prior art techniques for processing non-aqueous mixtures. Such settling techniques involve allowing the larger agglomerates to settle over time (e.g., to the bottom of the processing container), so that they are removed from further processing. The increased particle dispersibility resulting from methods of the present invention leads to non-aqueous mixtures (even mixtures that include a high weight percentage of particles) that are stable for long periods of time and, thus, may not have any particle settling effects.

In some cases, the non-aqueous mixtures may be further processed to form composite layers that include the dielectric particles dispersed in a polymeric material. Any suitable technique may be used to form the composite layer. Generally, the non-aqueous mixture is cast on a substrate and heated to evaporate the non-aqueous solvent and to form the composite layer. If a curing agent and epoxy polymeric precursor are utilized, the epoxy may be cured during the heating step. The substrate may be, for example, a conductive substrate capable of functioning as an electrode. Additional processing may include providing additional layers (including a second electrode) on the composite layer and/or substrate to form the final structure. In some cases, a printed circuit board that includes the composite layer is formed. Structures formed using the methods of the present invention including polymeric material and dielectric composite layers are described further below.

As noted above, other methods of the invention do not involve drying the particles after the solvent replacement step. In these methods, the particles are maintained in the non-aqueous mixture formed in the solvent replacement step and further processed to form the desired final structure. Because the drying step is eliminated, particle agglomeration during drying is avoided. Thus, these methods of the present invention also result in production of dispersible barium titanate-based particles.

In these embodiments, the non-aqueous mixture formed in the solvent replacement step may be further processed according to any of the techniques described in connection with the processing of the non-aqueous mixture formed after drying. For example, the non-aqueous mixture formed in the solvent replacement step may be subjected to a high shear mixing and/or wet milling step.

It should also be understood that the non-aqueous mixture formed in the solvent replacement step may include a range of different weight percentages of particles, as described above. The weight percentage of particles in the mixture depends on the subsequent processing steps.

In these embodiments that do not utilize a drying step, the non-aqueous mixture formed in the solvent replacement step includes a non-aqueous solvent that is compatible with subsequent processing steps. In processes which involve processing the non-aqueous mixtures to form polymer and dielectric composite layers, MEK, MIBK (4 methyl-2pentanone), or NMP (1-methyl, 2 pyrrolidnone) may be the preferred non-aqueous solvent. It should also be understood that non-aqueous mixture formed in the solvent replacement step may include any additional components as required for further processing.

The non-aqueous mixture formed in the solvent replacement step may be processed to form composite dielectric layers as described above in connection with the processing of the non-aqueous mixture formed after the drying.

The increased particle dispersibility obtainable using methods of the present invention can lead to a number property advantages for structures formed using such particles including dielectric and polymeric material composite layers. Such advantages may be achievable in particles produced in methods of the invention that utilize a drying step and methods of the invention that avoid drying the particles. In dielectric and polymeric material composite layers, the advantages result from the increased uniformity of particle distribution throughout the polymeric material. The increased uniformity results in higher and more consistent capacitance values across the layer. This can also increase production yields by reducing the percentage of structures produced that have insufficient capacitance. Another advantage associated with increased particle uniformity in composite layers is the ability to form very thin layers which are desirable in a number of applications.

Increased particle dispersibility also leads to formation of dielectric and polymeric material composite layers having a very low surface roughness. For example, the surface roughness of the composite may be less than the primary particle size of the dielectric particle. In some cases, the surface roughness may be less than about 500 nm, in some cases, less than about 100 nm, and in other cases less than about 50 nm. These surface roughness values are achievable even when the composite layer includes a relatively high percentage of particles, for example, at least 50%, or at least 70%, by weight based on the total weight of the composite.

It should be understood that the dispersible particles formed using methods of the present invention may be processed to produce any desired structure.

The present invention will be further illustrated by the following examples, which are intended to be illustrative in nature and are not to be considered as limiting the scope of the invention.

### EXAMPLE 1

A composite layer including barium titanate-based particles distributed in a polymeric material was formed using a conventional method and characterized.

The method involved hydrothermally producing barium titanate-based particles. After the hydrothermal process, the particles were maintained in an aqueous mixture. The particles in the aqueous mixture were dried in a vacuum drier at 200° C. The dried particles were subjected to screening step using a standard vibratory screen having a 200 mesh size with media.

125 g of the dried particles were added to a non-aqueous solvent mixture. The non-aqueous solvent mixture included 61 g of non-aqueous solvent (MEK, manufactured by Sigma-Aldrich (Milwaukee, Wis.), 15.75 g of epoxy resin precursor (PolyBisphenol A-coepichlorohydrin glycidil end-capped, manufactured by Aldrich), and 2.5 g of dispersant (Hypermer PS3, manufactured by ICI Surfactants). The particle and non-aqueous solvent mixture was emulsified using a high shear mixer for 1 minute.

The mixture was then hand cast onto a copper foil substrate (supplied by McMaster Carr) using a 3.0 mil gap. The cast layer was air dried in a fume hood to form a composite layer including the barium titanate-based particles distributed in a polymeric material.

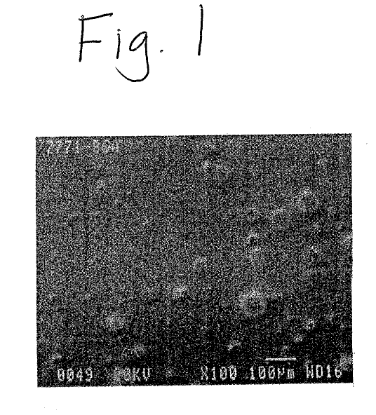

The surface of the composite layer was examined using a scanning electron microscope (SEM). FIG. 1 is an SEM photo at 100× of a representative area on the sample. The sample includes large amounts of particle agglomeration including a large number of agglomerates on the order of 100 microns.

The example illustrates the presence of significant particle agglomeration in a composite layer formed using a conventional method.

### EXAMPLE 2

A composite layer including barium titanate-based particles distributed in a polymeric material was formed using one method of the present invention and characterized.

Barium titanate-based particles were hydrothermally produced and maintained in an aqueous mixture as described above in Example 1. The water in the aqueous mixture was replaced, in part, with ethanol using a filtration technique to form a non-aqueous mixture. The particles in the non-aqueous mixture were dried in a vacuum drier at 140° C. The dried particles were subjected to a hammer milling step as described above in Example 2. A composite layer including the barium titanate-based particles distributed in a polymeric material was formed as described above in Example 1.

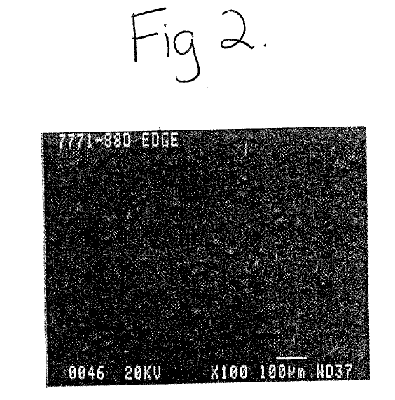

The surface of the composite layer was examined using a scanning electron microscope (SEM). FIG. 2 is an SEM photo at 100× of a representative area on the sample. The sample includes greatly reduced particle agglomeration as compared to Examples 1. The largest agglomerates are on the order of 20 microns.

This example illustrates the reduction of particle agglomeration in a polymeric material and dielectric composite layer formed using a method of the present invention.

Although particular examples and embodiments of the invention have been described in detail for purposes of illustration, various changes and modifications may be made without departing from the scope and spirit of the invention. Accordingly, the invention is not to be limited except by the appended claims.

What is claimed is:

1. A method of forming a composite structure comprising:
forming an aqueous mixture including barium titanate-based particles and water;
replacing at least a portion of the water in the aqueous mixture with a non-aqueous solvent to form a non-aqueous mixture including the non-aqueous solvent and the barium titanate-based particles;
drying the barium titanate-based particles in the non-aqueous mixture;
mixing the dried barium titanate-based particles with a second non-aqueous solvent and a precursor of polymeric material to form a second non-aqueous mixture; and
removing the second non-aqueous solvent from the second non-aqueous mixture to form a composite structure including barium titanate-based particles distributed in the polymeric material.

2. The method of claim 1, further comprising milling the dried barium titanate-based particles prior to mixing the dried barium titanate-based particles with the second non-aqueous solvent and the precursor of polymeric material.

3. The method of claim 2, comprising hammer milling the dried barium titanate-based particles prior to mixing the dried barium titanate-based particles with the second non-aqueous solvent and the precursor of polymeric material.

4. The method of claim 1, further comprising screening the dried barium titanate-based particles prior to mixing the dried barium titanate-based particles with the second non-aqueous solvent and the precursor of polymeric material.

5. The method of claim 1, further comprising high shear mixing the second non-aqueous mixture prior to removing the second non-aqueous solvent.

6. The method of claim 1, further comprising wet milling the second non-aqueous mixture prior to removing the second non-aqueous solvent.

7. The method of claim 1, wherein the replacing step comprises removing at least a portion of the water from the aqueous mixture followed by adding the non-aqueous solvent to form the non-aqueous mixture.

8. The method of claim 7, comprising removing substantially all of the water from the aqueous mixture.

9. The method of claim 7, wherein the replacing step includes filtering the aqueous mixture to remove at least a portion of the water prior to the addition of the non-aqueous solvent to form the non-aqueous mixture.

10. The method of claim 9, further comprising filtering at least some of the non-aqueous solvent while adding the non-aqueous solvent to form the non-aqueous mixture.

11. The method of claim 1, wherein the aqueous mixture is an aqueous wet cake or an aqueous slurry.

12. The method of claim 1, wherein the non-aqueous mixture is a non-aqueous wet cake or a non-aqueous slurry.

13. The method of claim 1, wherein the non-aqueous mixture includes water.

14. The method of claim 1, wherein the non-aqueous solvent has a surface tension less than the surface tension of water.

15. The method of claim 1, further comprising casting the non-aqueous mixture on a substrate prior to removing the second non-aqueous solvent from the non-aqueous mixture to form the composite structure as a composite layer on the substrate.

16. The method of claim 15, wherein the substrate is conductive and further comprising forming a conductive layer on the composite layer to form a sandwich structure.

17. The method of claim 16, wherein the sandwich structure is processed to form a printed circuit board.

18. The method of claim 1, wherein the non-aqueous mixture is not subjected to a settling step prior to removing the second non-aqueous solvent.

19. The method of claim 1, wherein the precursor of polymeric material is dissolved in the second non-aqueous solvent.

20. The method of claim 1, wherein the polymeric material is an epoxy.

21. The method of claim 1, wherein the second non-aqueous solvent is removed by evaporation.

22. The method of claim 1, further comprising forming the barium titanate-based particles in a hydrothermal process.

23. The method of claim 22, wherein the barium titanate-based particles are maintained in water after the hydrothermal process to form the aqueous mixture.

24. The method of claim 1, wherein the barium titanate-based particles are uncoated.

25. The method of claim 1, wherein the non-aqueous solvent is ethanol.

26. A method of forming a composite structure comprising:
forming an aqueous mixture including barium titanate-based particles and water;
replacing at least a portion of the water in the aqueous mixture with a non-aqueous solvent to form a non-aqueous mixture including the non-aqueous solvent and the barium titanate-based particles;
adding a precursor of a polymeric material to the non-aqueous mixture; and
removing the non-aqueous solvent from the non-aqueous mixture to form a composite structure including barium titanate-based particles distributed in the polymeric material.

27. The method of claim 26, further comprising high shear mixing the non-aqueous mixture prior to removing the non-aqueous solvent.

28. The method of claim 26, further comprising wet milling the non-aqueous mixture prior to removing the non-aqueous solvent.

29. The method of claim 26, wherein the replacing step comprises removing at least a portion of the water from the aqueous mixture followed by adding the non-aqueous solvent to form the non-aqueous mixture.

30. The method of claim 29, comprising removing substantially all of the water from the aqueous mixture.

31. The method of claim 29, wherein the replacing step includes filtering the aqueous mixture to remove at least a portion of the water prior to the addition of the non-aqueous solvent to form the non-aqueous mixture.

32. The method of claim 31, further comprising filtering at least some of the non-aqueous solvent while adding the non-aqueous solvent to form the non-aqueous mixture.

33. The method of claim 27, wherein the aqueous mixture is an aqueous wet cake or an aqueous slurry.

34. The method of claim 27, wherein the non-aqueous mixture is a non-aqueous wet cake or a non-aqueous slurry.

35. The method of claim 27, wherein the non-aqueous mixture includes water.

36. The method of claim 27, wherein the non-aqueous solvent has a surface tension less than the surface tension of water.

37. The method of claim 27, further comprising casting the non-aqueous mixture on a substrate prior to removing the non-aqueous solvent from the non-aqueous mixture to form the composite structure as a composite layer on the substrate.

38. The method of claim 37, wherein the substrate is conductive and further comprising providing a conductive layer on the composite layer to form a sandwich structure.

39. The method of claim 38, wherein the sandwich structure is processed to form a printed circuit board.

40. The method of claim 39, wherein the non-aqueous mixture is not subjected to a settling step prior to removing the non-aqueous solvent.

41. The method of claim 27, wherein the precursor of polymeric material is dissolved in the second non-aqueous solvent.

42. The method of claim 27, wherein the polymeric material is an epoxy.

43. The method of claim 27, wherein the second non-aqueous solvent is removed by evaporation.

44. The method of claim 27, further comprising forming the barium titanate-based particles in a hydrothermal process.

45. The method of claim 44, wherein the barium titanate-based particles are maintained in water after the hydrothermal process to form the aqueous mixture.

46. The method of claim 45, wherein the barium titanate-based particles are not dried after the hydrothermal process and prior to removing the second non-aqueous solvent.

47. The method of claim 1, wherein the barium titanate-based particles are uncoated.

48. A composite layer including barium titanate-based particles distributed in a polymeric material, the barium titanate-based particles being present in an amount of at least 50 percent by weight of the total composite layer, the composite layer having a surface roughness of less than about 500 nm.

49. The composite layer of claim 48, wherein the composite layer has a surface roughness of less than about 100 nm.

50. The composite layer of claim 48, wherein the composite layer has a surface roughness of less than about 50 nm.
